(19) United States
(12) Patent Application Publication
(10) Pub. No.: US 2010/0019614 A1
(43) Pub. Date: Jan. 28, 2010

(54) SYNCHRONOUS MACHINE AND ALSO METHOD FOR MANUFACTURING SUCH A SYNCHRONOUS MACHINE

(76) Inventors: Peter Ulrich Arend, Rheinfelden (DE); Nagib Rajput, Wettingen (CH)

Correspondence Address: CERMAK KENEALY VAIDYA & NAKAJIMA LLP, 515 E. BRADDOCK RD, ALEXANDRIA, VA, 22314, US

(21) Appl. No.: 12/507,174

(22) Filed: Jul. 22, 2009

(30) Foreign Application Priority Data
Jul. 24, 2008 (CH) 01154/08

(51) Int. Cl. H02K 1/27; H02K 15/02; H02K 1/28

(52) U.S. Cl. 310/216.106; 29/598; 310/216.135

(57) ABSTRACT

A synchronous machine (10), especially a turbogenerator, includes a rotor (12) rotatable about a rotor axis, the rotor being concentrically surrounded by a stator (11), with an air gap (26) between said rotor (12) and stator (11), and includes a rotor damping system (14). Damping losses are substantially reduced by providing a system in the air gap (26) for controlling the stator magnetic field (13).

This application claims priority under 35 U.S.C. §119 to Swiss application no. 01154/08, filed 24 Jul. 2009, the entirety of which is incorporated by reference herein.

### BACKGROUND

1. Field of Endeavor

The present invention relates to the field of rotating electrical machines. It concerns a synchronous machine and a method for manufacturing a synchronous machine.

2. Brief Description of the Related Art

Synchronous machines in general, and turbogenerators in particular, are provided as standard with a rotor damping system (see, for example, FIG. 6 in L. Busse; K.-H. Soyk “World's highest capacity steam turbosets for the lignite-fired Lippendorf power station”, ABB Review June 1997, pp. 13-22). This damping system is live

in cases of unsteady operation (rotary oscillations, changes in rotational speed, switching operations and malfunctions (such as for example sudden short circuits)),

in spatial or temporal magnetic field harmonics (such as occur, for example, in faults between windings or during power converter operation),

during non-symmetrical operation (for example unbalanced load, internal incidents (for example, a fault between windings) and external incidents (for example, failure of power converter valves, a single-phase short circuit)).

The damper currents occurring in these cases of operation or incidents counteract the change in magnetic field infiltrating the rotor from the stator. As a result, the field increase within the rotor is greatly reduced. However, the tangential magnetic field strength in the air gap (between the stator and rotor) increases markedly. This situation is illustrated in highly simplified form in FIG. 1: The synchronous machine 10 (for example a turbogenerator) includes a central rotor 12 which is concentrically surrounded by a stator 11. An annular air gap 26 is located between the two. In the case of steady operation (left-hand partial FIG. 1(a)) with symmetrical feeding without harmonics, the stationary magnetic field 13 passes for the most part through the rotor 12.

In other cases of operation or incidents in which damper currents 14 are active in the rotor 12 (right-hand partial FIG. 1(b)), the magnetic field component, which changes over time from the perspective of the rotor, is urged out of the rotor interior and has a strong tangential component in the air gap 26.

The induced damper currents 14, which in FIG. 1(b) flow on the right-hand side of the rotor 12 into the drawing plane and on the left-hand side out of the drawing plane, are linked with electrical losses which must additionally be discharged from the synchronous machine 10. It is desirable, especially in the case of permanently applied harmonics and/or non-symmetry, to reduce these losses in a simple manner without otherwise impairing the electromechanical power conversion of the synchronous machine.

### SUMMARY

One of numerous aspects of the present invention includes a synchronous machine which has a damping system and is distinguished, based on simple design changes, by greatly reduced damping losses, and also a method for the manufacture thereof.

Another aspect of the present invention includes a device or system in the air gap for controlling the stator magnetic field.

According to a preferred exemplary embodiment of the invention, the device or system for controlling the stator magnetic field includes a magnetizable casing which at least partly covers the surface of the rotor that is penetrated by the basic work field of the machine. The magnetizable casing reduces the magnetic resistance transversely to the air gap (i.e., in the tangential direction). If specific cases of operation or incidents give rise in the rotor to damper currents which deflect the stator magnetic field transversely to the air gap (tangentially), the magnetic flux impressed by the stator then permeates the magnetizable casing. The necessary magnetization current (=MMF=magnetomotive force=magnetic tension in the tangential direction) is then lower, owing to the casing, than in a conventional design without the casing. The necessary damper current is therefore lower. Because the electrical losses are accompanied to the power of two by the current intensity, this produces a superproportional reduction of the losses in the rotor damper.

Preferably, the magnetizable casing surrounds the rotor in the form of one or more magnetizable rings.

In particular, the magnetizable rings each include, directly adjoining one another in a concentric arrangement, an inner ring and an outer ring, the inner ring containing magnetizable material, and the outer ring is embodied for protecting the inner ring from the centrifugal forces occurring as the rotor rotates.

It is advantageous if the outer ring is formed of a fiber-reinforced composite material, especially if the outer ring contains carbon fibers for fiber reinforcement and the carbon fibers are oriented in the circumferential direction.

Furthermore, it is advantageous if the inner ring is formed of sintered material, especially of what is known as composite-shield material.

An exemplary method embodying principles of the present invention for manufacturing the synchronous machine includes that the ring or rings are manufactured in a first step and in that the finished rings are slid over the rotor in a second step. The end caps, which are used in the conventional manner to protect the rotor end windings from centrifugal force, are drawn on last.

One embodiment of the method according to the invention is distinguished in that, during the manufacture of a ring, in a first partial step an inner ring is first made from magnetizable material, especially by sintering what is known as a composite-shield material, and in that in a second partial step the inner ring is provided with a concentric outer ring for the purposes of mechanical reinforcement.

In particular, the procedure is in this case such that in the second partial step the inner ring is sheathed with carbon fiber mats impregnated by epoxy resin, the carbon fibers being oriented mainly in the circumferential direction, and that the carbon fiber composite is subsequently baked under pressure.

In order for cooling of the exciting winding and the rotor body to be ensured despite the rings, it is advantageous if the rings are provisioned, especially in the form of openings, for guiding cooling air. In addition, gaps for guiding cooling air can be provided between a plurality of rings arranged one after another in the axial direction.

Preferably, after manufacture and before being slid onto the rotor, the ring or rings are mechanically machined and provided with structure for guiding cooling air.

Another embodiment of the synchronous machine according to the invention is distinguished in that the rings are designed in such a way that increases in the rotor diameter during operation, especially as a result of a temperature rise and centrifugal forces, are tolerated. Preferably, the rings sit on the rotor almost without play and are secured so that the rings rotate therewith.

A further embodiment of the rings is distinguished in that, on the inner ring, the composite-shield material is slotted in the axial direction to reduce possible stresses, caused by temperature and centrifugal forces during operation.

### BRIEF DESCRIPTION OF THE DRAWINGS

The invention will be described hereinafter in greater detail based on exemplary embodiments and in conjunction with the drawings, in which:

FIG. 1 shows schematically, in two partial FIGS. 1(a) and 1(b), the formation of the stator magnetic field without and with an active rotor damping system in a conventional synchronous machine;

FIG. 2 shows schematically, in two partial FIGS. 2(a) and 2(b), the formation of the stator magnetic field without and with an active rotor damping system in a synchronous machine according to one exemplary embodiment of the invention;

FIG. 3 shows the construction of a magnetizable ring for the rotor according to another exemplary embodiment of the invention;

FIG. 4 shows an enlarged detail from FIG. 3; and

FIG. 5 shows the rotor of a large turbogenerator with a plurality of magnetizable rings arranged one after another in the axial direction according to a further exemplary embodiment of the invention.

### DETAILED DESCRIPTION OF EXEMPLARY EMBODIMENTS

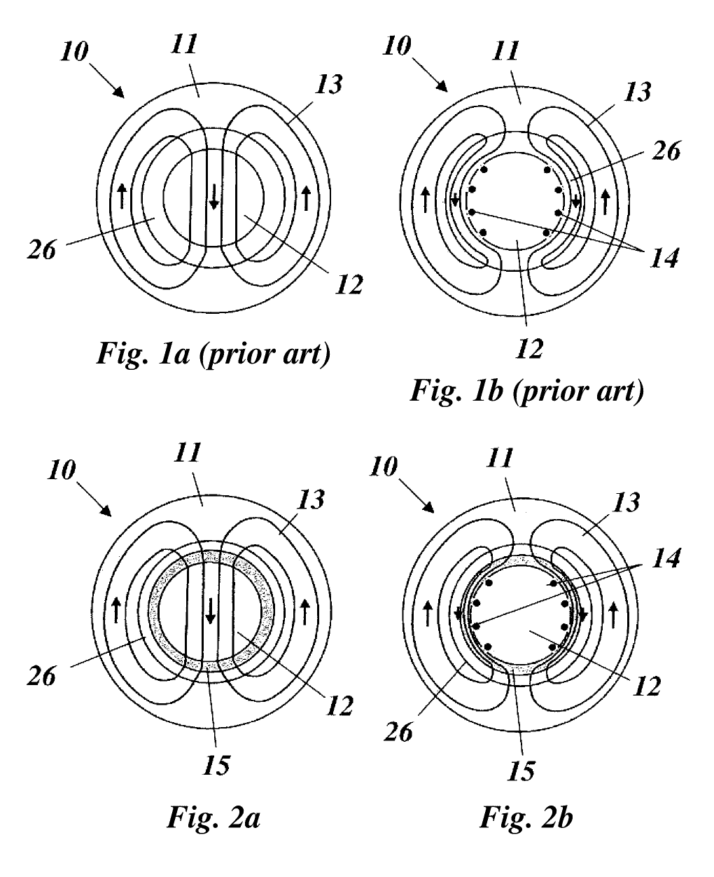

FIG. 2 represents the effect of the measure(s) according to principles of the invention in simplified form and in comparison to FIG. 1: The rotor 12 of the synchronous machine 10 is surrounded by a magnetizable casing 15 which reaches into the air gap 26 and preferably annularly surrounds the rotor 12. In the case of steady operation without field harmonics and without non-symmetry (FIG. 2(a)), when no damper currents are induced, the stator magnetic field 13 of the stator 11 passes through the rotor 12 in the manner known from FIG. 1(a). In other cases of operation or incidents, damper currents 14 are induced (FIG. 2(b)) which urge the stator magnetic field 13 out of the rotor 12 and deflect it in the tangential direction (circumferential direction) predominantly through the magnetizable casing 15.

The magnetizable casing 15 is preferably made of what is known as a composite-shield material. Composite-shield materials are composite materials which are formed of fine iron particles embedded in plastics material. The permeability of the iron particles and the density thereof determine the magnetizability of the material. The plastics material acts as a mechanical carrier substance and at the same time as electrical insulation, so that the resulting electrical conductivity is very low. These substances are thus ideally suitable for ‘diverting’ alternating magnetic fluxes without the formation of eddy currents and accompanying heat production or a rise in temperature.

The composite-shield material in the magnetizable casing or ring 15 reduces the magnetic resistance transversely to the air gap (i.e., in the tangential direction). The above-mentioned particular cases of operation or incidents produce in the rotor 12 damper currents 14 which deflect the stator magnetic field 13 transversely to the air gap 26 (tangentially). The magnetic flux impressed by the stator 11 then permeates the casing 15. The necessary magnetization current is in this case lower than in a conventional design without the casing 15. The necessary damper current 14 is therefore also lower. Because the electrical losses are accompanied to the power of two by the current intensity, this produces a superproportional reduction of the losses in the rotor damper.

Rapidly produced heat in the damping system, such as occurs in unsteady processes, leads, owing to the effectiveness of heat capacities in general, to an uncritical excess rise in temperature. Conversely, heat production is sustained in cases of steady operation with a non-symmetrical stator current system and/or a higher stator current harmonic. The heat capacities are then irrelevant for the steadily occurring temperature. Use of composite-shield materials is particularly effective here, because they reduce the production of heat in the damping system and thus lower the steady operating temperature.

The magnetizable casing 15 is advantageously designed in such a way that the basic work field excited by the stator currents (steady stator magnetic field 13 in FIG. 2(a) without temporal or spatial magnetic field harmonics and without non-symmetry) penetrates for the most part the rotor body of the rotor 12. Otherwise, the electromagnetic power level is not ensured. The increased requirement for rotor exciting current must be taken into account in this regard.

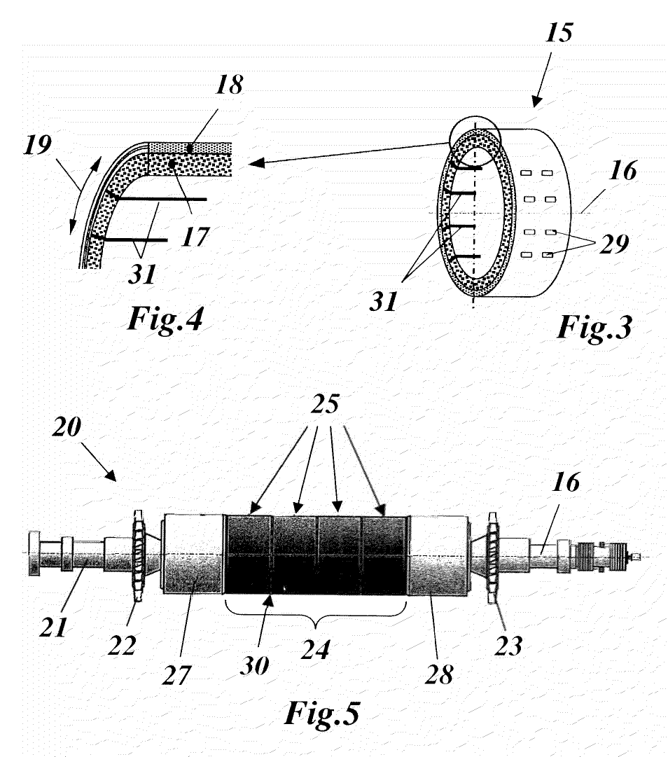

One possible embodiment is provided in accordance with FIGS. 3-5, as follows: The rotor 20, with its rotor shaft 21 and the fans 22, 23 arranged at both ends, extends along the rotor axis 16. The composite-shield material is preproduced in the form of rings 15 and 25 respectively and drawn over the rotor 20 during assembly in the axial direction. The embodiment with a plurality of rings 25 over the axial length of the rotor 20 helps to simplify production, transportation and assembly. Holes and slots 29 in the rings 15, 25 and also gaps 30 (in the axial direction) between the rings 25 can be used to guide cooling air. The magnetizable rotor rings 15, 25 are in this case preferably designed in such a way that increases in the rotor diameter during operation (as a result of temperature and centrifugal force) are tolerated.

In order to protect the magnetic shield material from centrifugal forces, the magnetic rings are embodied (as illustrated in FIGS. 3 and 4) with two materials in two mutually separated layers. This produces an inner ring 17 made of magnetizable composite-shield material (sintered) and an outer ring 18 made of carbon fiber material (baked).

The manufacture can take place in the following manner: The magnetizable inner ring 17 is sintered from soft magnetic composite-shield material at 1,100° C. for approx. one hour. The fully sintered inner ring material is then heat-resistant up to 250° C.

Subsequently, the inner ring 17 is sheathed with carbon fiber mats impregnated by epoxy resin, the carbon fibers being oriented mainly in the circumferential direction (fiber orientation 19 in FIG. 4). The carbon fiber composite is baked under pressure at approximately 170° C. for 45 minutes.

The fully baked ring can then be mechanically machined in order to form the necessary ventilation holes and slots (29) for the purposes of ventilation and the reduction of mechanical stresses. Likewise, the inner ring 17 can be provided with axial slots 31 in order to reduce the mechanical stresses during operation, especially as a result of a temperature rise and centrifugal forces.

Before the end caps 27, 28 are drawn onto the rotor 20, the rings (cylinders) 25 are slid over the rotor body, so that they cover the active part of the rotor winding 24. In order to prevent twisting, the balancing holes and central centerings can be designed in such a way as to provide them with cylindrical pins.

However, as an alternative to the procedure described hereinbefore, it is also conceivable to mount the rings 15 statically in the rotor 11.

List of Reference Signs

10 synchronous machine (turbogenerator)

11 stator

12 rotor

13 stator magnetic field

14 damper current

15 magnetizable casing (ring)

16 rotor axis

17 inner ring (magnetic sinter material)

18 outer ring (carbon fiber)

19 fiber orientation (carbon fiber)

20 rotor

21 rotor shaft

22, 23 fan

24 rotor winding (active part)

25 magnetizable ring

26 air gap

27, 28 end cap (for protecting the rotor end winding from centrifugal force)

29 slot

30 gap

31 slot

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A synchronous machine comprising:
a rotor rotatable about a rotor axis;
a stator concentrically surrounding the rotor with an air gap between the rotor and the stator;
a rotor damping system; and
means for controlling the stator magnetic field positioned in said air gap.

2. The synchronous machine as claimed in claim 1, wherein:
rotor includes a rotor surface that is penetrated by the basic work field of the machine; and
the means for controlling the stator magnetic field comprises a magnetizable casing which at least partly covers the rotor surface.

3. The synchronous machine as claimed in claim 2, wherein the magnetizable casing comprises at least one magnetizable ring.

4. The synchronous machine as claimed in claim 3, wherein:
each of the at least one magnetizable ring comprises an inner ring and an outer ring concentrically directly adjoining one another;
the inner ring comprises magnetizable material; and
the outer ring is configured and arranged to protect the inner ring from centrifugal forces occurring when the rotor rotates.

5. The synchronous machine as claimed in claim 4, wherein the outer ring comprises a fiber-reinforced composite material.

6. The synchronous machine as claimed in claim 5, wherein the outer ring contains circumferentially oriented carbon fibers.

7. The synchronous machine as claimed in claim 4, wherein the inner ring comprises sintered material.

8. The synchronous machine as claimed in claim 7, wherein sintered material comprises composite-shield material.

9. The synchronous machine as claimed in claim 3, wherein the at least one magnetizable ring comprises means for guiding cooling air.

10. The synchronous machine as claimed in claim 3, wherein the at least one magnetizable ring comprises openings configured and arranged to guide cooling air.

11. The synchronous machine as claimed in claim 3, wherein the at least one magnetizable ring comprises a plurality of axially spaced magnetizable rings, and further comprising:
gaps for guiding cooling air between the plurality of magnetizable rings.

12. The synchronous machine as claimed in claim 3, wherein the at least one magnetizable ring is configured and arranged to tolerate increases in the rotor diameter during operation.

13. The synchronous machine as claimed in claim 10, wherein the at least one magnetizable ring is secured on the rotor almost without play so that the at least one magnetizable ring rotates with the rotor.

14. The synchronous machine as claimed in claim 8, wherein the inner ring composite-shield material comprises axial slots configured and arranged to reduce stresses caused by temperature and centrifugal forces during operation.

15. A method for manufacturing a synchronous machine as claimed in claim 3, the method comprising:
first, forming the at least one magnetizable ring; and
second, sliding the at least one magnetizable ring over the rotor.

16. The method as claimed in claim 15, wherein forming the at least one magnetizable ring comprises:
forming an inner ring from magnetizable material; and
forming a concentric, mechanical reinforcement outer ring around the inner ring.

17. The method as claimed in claim 16, wherein forming an inner ring from magnetizable material comprises sintering a composite-shield material.

18. The method as claimed in claim 16, wherein forming the outer ring comprises:
sheathing the inner ring with a carbon fiber composite comprising carbon fiber mats impregnated with epoxy resin, carbon fibers of the carbon fiber mats being oriented mainly in the circumferential direction; and
thereafter, baking the carbon fiber composite under pressure.

19. The method as claimed in claim 15, further comprising, between said forming and said sliding:
mechanically machining the at least one magnetizable ring to form means for guiding cooling air.

20. The method as claimed in claim 15, further comprising, after said sliding, drawing end caps onto the rotor.
